(19) United States
(12) Patent Application Publication
(10) Pub. No.: US 2010/0144474 A1
(43) Pub. Date: Jun. 10, 2010

(54) BELT UNIT FOR CONTINUOUSLY VARIABLE TRANSMISSION

(75) Inventors: Juhyeong Lee, Hwaseong-si (KR); Jaehyun Lee, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/619,294

(22) Filed: Nov. 16, 2009

(30) Foreign Application Priority Data
Dec. 4, 2008 (KR) 10-2008-0122664

(51) Int. Cl. F16G 1/22

(52) U.S. Cl. 474/240

(57) ABSTRACT

A belt unit for a continuously variable transmission that transmits power from a primary pulley to a secondary pulley, may include at least a band overlapped each other, and a segment including a body base and a locking end portion which are connected by a neck therebetween, wherein an upper surface of the at least a band is coupled to the locking end portion and a lower surface of the at least a band is coupled to a segment shoulder of the body base, and wherein lower grooves are formed at lower portions of the neck between the neck and the segment shoulder of the body base at both sides of the neck such that an upper surface of the respective body base is higher than the corresponding lower groove to form a contact radius difference between the lower groove and the upper surface of the body base.

### CROSS-REFERENCE TO RELATED APPLICATIONS

The present application claims priority to Korean Application Serial Number 10-2008-0122664, filed on Dec. 4, 2008, the entire contents of which are incorporated herein for all purposes by this reference.

### BACKGROUND OF THE INVENTION

1. Field of the Invention

The present invention relates to a continuously variable transmission, particularly a belt unit for a continuously variable transmission that removes a relative velocity difference that causes slip under an OD (Over Drive, 2000 rpm) condition which is most used in practical traveling conditions of a vehicle.

2. Description of Related Art

In general, CVTs (Continuously Variable Transmission) is devices that transmit power using a belt connecting a primary pulley with a secondary pulley, in which the primary pulley is connected with a power shaft and the secondary pulley is connected with a driven shaft.

For this purpose, the belt is composed of segments and bands and the segment has a structure in which a plurality of bands arranged to overlap each other is inserted.

The belt is a main component for transmitting power in a CVT and various friction losses occur due to relative motions between the components of the CVT.

For example, the friction loss is generated between a segment and the pulley surface as well as between a segment and a band, and a band and a band, and other losses are generated.

However, about 65 to 75% of the friction loss generated in a CVT is a loss due to band friction, which is a friction loss due to relative motion between a segment and a band and normal force exerted in a segment shoulder where the band is in close contact by pulley compression force.

It is required to reduce a relative velocity difference between a band and a segment to increase the performance efficiency of a CVT, which depends on that the normal force of the segment shoulder is determined by the engine input torque, in the compression force of the pulley.

For example, slip between a band and a segment is caused by the fact that the band radius is larger than the segment radius, that is, the slip is generated at a small contact radius side. Accordingly, since the radii of the driving shaft and the driven shaft are variable, the slip occurs at the driving shaft with a small contact radius for a large transmission ratio and the slip occurs at the driven shaft with a small contact radius for a small transmission ratio, and particularly, the slip is the largest at the driven shaft under an over drive condition.

Accordingly, the shape of a segment has been continuously developed and researched to reduce the relative velocity difference between a band and the segment.

However, slip between a pulley and a segment should be considered to reduce the relative velocity difference between a band and the segment because the slip substantially influences the relative velocity difference. But, since only the linear velocity difference between the band and the segment is considered to reduce the relative velocity difference, there is a limit in improving performance for reducing the relative velocity difference.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to remove a relative velocity difference between a band and a segment, and particularly remove a relative velocity difference between a band and a segment under an OD (Over Drive, 2000 rpm) condition which is most used in practical traveling conditions of a vehicle, by calculating a contact radius difference (height difference of segment shoulder surface) of the band and the segment in consideration of a linear velocity difference between the segment and the band of a belt for a CVT and slip between a pulley and the segment.

In an aspect of the present invention, the belt unit for a continuously variable transmission that transmits power from a primary pulley of the continuously variable transmission to a secondary pulley, may include at least one band overlapped each other, and a plurality of segments that have a space where the band is disposed, and have segment shoulders, where the band is inserted, at both sides, wherein lower grooves are formed at portions that divide the segment shoulders at both sides such that a contact radius difference is formed between the groove and the segment shoulder.

The contact radius difference may be approximately 0.27 mm under an OD (Over Drive, approximately 2000 rpm) condition.

The contact radius difference may be increased by approximately 0.1 mm at a time from approximately 0.27 mm.

The contact radius difference may be calculated by (0.001−ΔR)×RPM×2×(3.14/60)=ΔV, where ΔR is a height difference of segment, RPM is a revolution number of engine, ΔV is a relative velocity difference between the band and the segment.

In another aspect of the present invention, the belt unit for a continuously variable transmission that transmits power from a primary pulley of the continuously variable transmission to a secondary pulley, may include at least a band overlapped each other, and a segment including a body base and a locking end portion which are connected by a neck therebetween, wherein an upper surface of the at least a band is coupled to the locking end portion and a lower surface of the at least a band is coupled to a segment shoulder of the body base, and wherein lower grooves are formed at lower portions of the neck between the neck and the segment shoulder of the body base at both sides of the neck such that an upper surface of the respective body base is higher than the corresponding lower groove to form a contact radius difference between the lower groove and the upper surface of the body base.

The belt unit for a continuously variable transmission may further include upper grooves formed at upper portions of the neck between the neck and the locking end portion at both sides of the neck such that a lower surface of the respective locking end portion is lower than the corresponding upper groove.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a diagram illustrating the configuration of a belt unit for a continuously variable transmission according to an exemplary embodiment of the present invention; and

FIGS. 2A to 2C show power loss performance tables of a CVT equipped with a belt unit according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

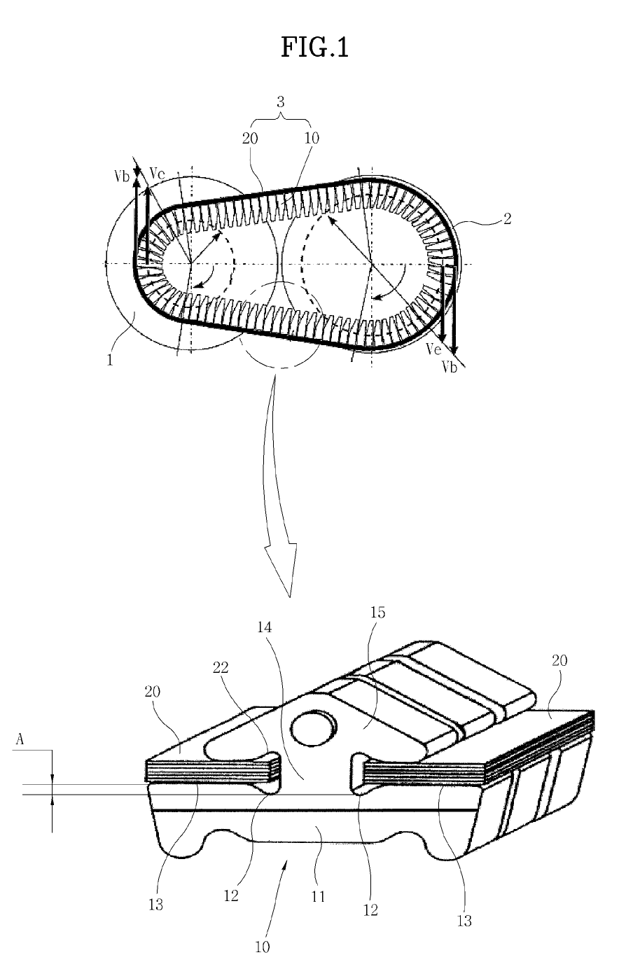

FIG. 1 is a diagram illustrating the configuration of a belt unit for a continuously variable transmission according to an exemplary embodiment of the present invention. A CVT (Continuously Variable Transmission) of the present invention includes a primary pulley connected with a power shaft, a secondary pulley connected with a driven shaft, and a belt unit 3 transmitting power from primary pulley 1 to secondary pulley 2.

In the CVT, since the driving shaft and the driven shaft can move in the axial directions, the radii of belt unit 3 contacting with the driving shaft and the driven shaft are changed.

Belt unit 3 includes a plurality of segments 10 and at least one band 20, and two bands 20 are provided for one segment 10.

For this purpose, segment 10 has a body base 11 and a neck 14 connecting a locking end portion 15, which is the upper end of body base 11, such that band 20 is disposed around neck 14.

With this structure, the upper surface of band 20 is locked to locking end portion 15 and the lower surface thereof is locked to body base 11.

Further, body base 11 where the lower surface of band 20 is in contact with is a segment shoulder 13, and to implement this structure, body base 11 has grooves 12 at the connecting portions of neck 14 and segment shoulder 13 is the surface of body base 11 where grooves 12 are not formed.

In this structure, band 20 placed on segment shoulder 13 is positioned to neck 14 and is not supported due to a height difference ‘A’ from segment shoulder 13 at the portions where grooves 12 are formed.

Segment shoulder 13 is a main factor that prevents slip and increases transmission efficiency, and the height difference ‘A’ is obtained by the following equation.

Equation of calculating height difference ‘A’:

(0.001−ΔR)×RPM×2×(3.14/60)=ΔV

where ΔR is a height difference ‘A’ of segment, RPM is the revolution number of engine, ΔV is a relative velocity difference between the band and the segment.

By using the equation, the relative velocity difference ΔV between band 20 and segment 10 is removed, and particularly, an optimum ΔR without a relative velocity difference between the band and segment under an OD (Over Drive, 2000 rpm) condition that is most used in practical traveling conditions of a vehicle is calculated.

For example, ΔV is 0.153 m/s under transmission ratio of 0.492, 2000 rpm.

Accordingly, applying (0.001−ΔR)×2,000×2×(3.14/60)=0.153, ΔR is 0.27 mm, which is determined by the height difference of segment shoulder 13 of segment 10, in which there is no relative velocity difference between the band and the segment.

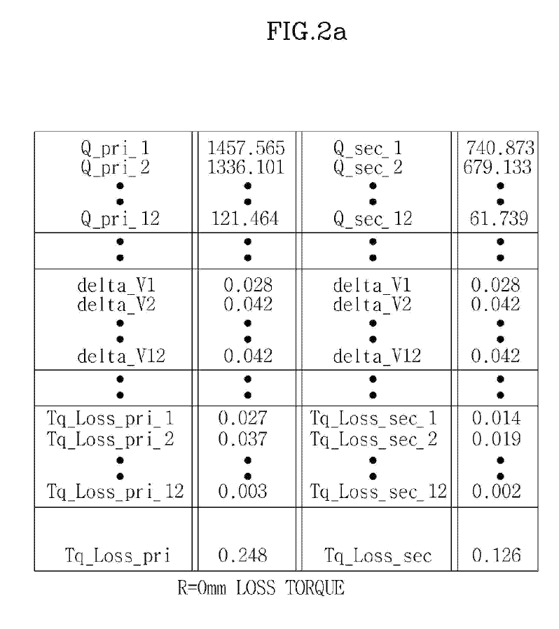

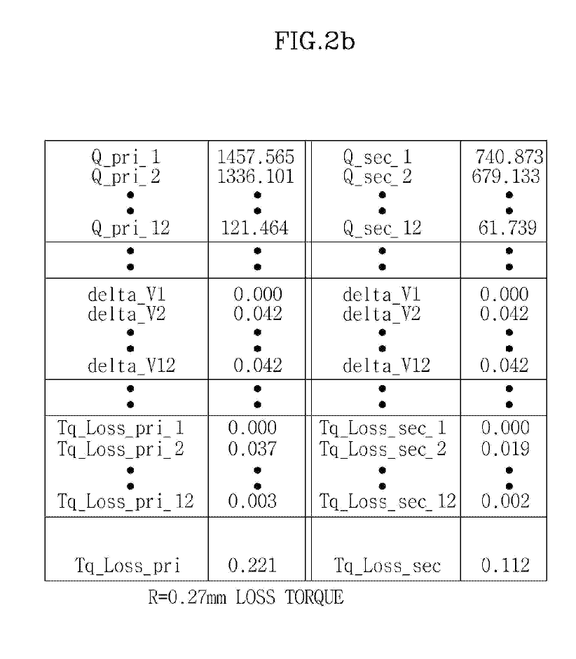

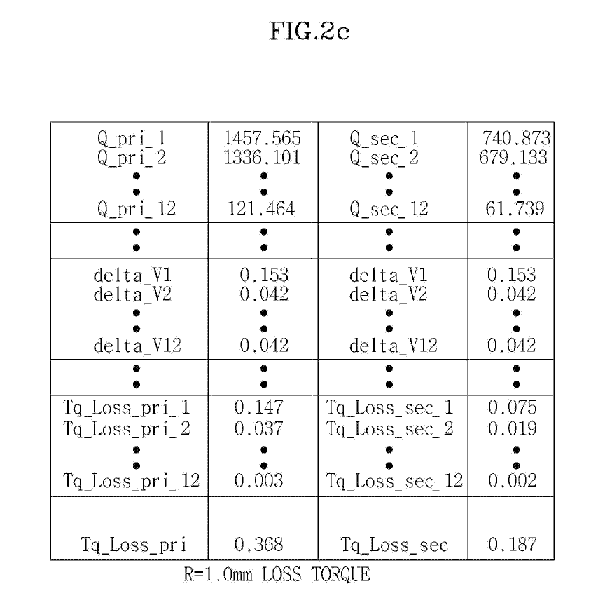

It can be seen that power transmission loss of the CVT using belt 3 having band 20 and segments 10, as shown in FIG. 2, is 0.333 kgfm, which is the minimum, at ΔR=0.27 mm.

For example, to calculate power transmission efficiency performance, that is, by exemplifying FIG. 2B, assuming that there is not relative velocity difference ‘delta_V1’ (assuming ‘delta_V1=0) between the first band and the segment by the ‘delta_V1’ obtained by analysis and experiment and ΔR for reducing the ‘delta_V1’, under transmission ratio of 0.492, 2000 rpm, and 9 kgfm, the band friction loss is 100−((0.221+0.112)/(0.368+0.187)*100=40%, such that the CVT transmission efficiency and durability can be improved.

Further, in this embodiment, it is preferable to increase ΔR of segment shoulder 13 by about 0.1 mm at a time, because it is preferable that the CVT efficiency is the most excellent at transmission ratio of 1:1 and it is determined within OD˜1:1 in consideration of a driving region with respect to the engine.

In another exemplary embodiment of the present invention, an upper groove 22 may be formed between the neck 14 and the locking end portion 15

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention he defined by the Claims appended hereto and their equivalents.

What is claimed is:

1. A belt unit for a continuously variable transmission that transmits power from a primary pulley of the continuously variable transmission to a secondary pulley, the belt unit comprising:
at least one band overlapped each other; and
a plurality of segments that have a space where the band is disposed, and have segment shoulders, where the band is inserted, at both sides,
wherein lower grooves are formed at portions that divide the segment shoulders at both sides such that a contact radius difference is formed between the groove and the segment shoulder.

2. The belt unit for a continuously variable transmission as defined in claim 1, wherein the contact radius difference is approximately 0.27 mm under an OD (Over Drive, approximately 2000 rpm) condition.

3. The belt unit for a continuously variable transmission as defined in claim 2, wherein the contact radius difference is increased by approximately 0.1 mm at a time from approximately 0.27 mm.

4. The belt unit for a continuously variable transmission as defined in claim 2, wherein the contact radius difference is calculated by (0.001−ΔR)×RPM×2×(3.14/60)=ΔV, where ΔR is a height difference of segment, RPM is a revolution number of engine, ΔV is a relative velocity difference between the band and the segment.

5. A belt unit for a continuously variable transmission that transmits power from a primary pulley of the continuously variable transmission to a secondary pulley, the belt unit comprising:
at least a band overlapped each other; and
a segment including a body base and a locking end portion which are connected by a neck therebetween,
wherein an upper surface of the at least a band is coupled to the locking end portion and a lower surface of the at least a band is coupled to a segment shoulder of the body base, and
wherein lower grooves are formed at lower portions of the neck between the neck and the segment shoulder of the body base at both sides of the neck such that an upper surface of the respective body base is higher than the corresponding lower groove to form a contact radius difference between the lower groove and the upper surface of the body base.

6. The belt unit for a continuously variable transmission as defined in claim 5, further including upper grooves formed at upper portions of the neck between the neck and the locking end portion at both sides of the neck such that a lower surface of the respective locking end portion is lower than the corresponding upper groove.

7. The belt unit for a continuously variable transmission as defined in claim 5, wherein the contact radius difference is approximately 0.27 mm under an OD (Over Drive, approximately 2000 rpm) condition.

8. The belt unit for a continuously variable transmission as defined in claim 7, wherein the contact radius difference is increased by approximately 0.1 mm at a time from approximately 0.27 mm.

9. The belt unit for a continuously variable transmission as defined in claim 7, wherein the contact radius difference is calculated by (0.001−ΔR)×RPM×2×(3.14/60)=ΔV, where ΔR is a height difference between the upper surface of the respective body base and the corresponding lower groove, RPM is a revolution number of engine, ΔV is a relative velocity difference between the band and the segment.
